(19) United States
(12) Patent Application Publication
(10) Pub. No.: US 2023/0001591 A1
(43) Pub. Date: Jan. 5, 2023

(54) KNIFE WITH REPLACEABLE BLADE

(71) Applicant: Mike H. Okamura, Boise, ID (US)

(72) Inventor: Mike H. Okamura, Boise, ID (US)

(21) Appl. No.: 17/364,923

(22) Filed: Jul. 1, 2021

(51) Int. Cl. B26B 5/00

(52) U.S. Cl. CPC B26B 5/00

(57) ABSTRACT

One or more embodiments of a device/knife for with a replaceable blade. The device may include a handle and a blade. The handle may include a grip, a pivot pin, and a latch. The pivot pin may have a first shape in a first plane. The blade may include an edged portion, a connection portion, and a tang. The connection portion may define an opening where the pivot pin is capable of entering into or exiting out of the opening of the connection portion if the pivot pin has a first orientation relative to the connection portion and the pivot pin is not capable of exiting out of the opening of the connection portion if the pivot pin has a second orientation. The latch may be configured to secure the tang of the blade when the pivot pin has the second orientation relative to the connection portion.

### FIELD OF THE DISCLOSURE

The present invention relates to devices for knives; specifically knives with replaceable blades.

### BACKGROUND

Knives may have blades of various lengths and shapes. Also knife blades can be damaged or worn out. Different knife blades may be useful for different tasks. For example, generally different blades would be used for carving wood and fileting fish. Knife handles are generally much thicker than the knife blades. Accordingly, someone with limited space, like a backpacker, may choose to carry a knife with replaceable blades.

Knives with replaceable blades exist in various forms. However, most knives with replaceable blades suffer in the areas of cleanliness, safety, and ease of use. Many knives with replaceable blades require the user to press on the blade in a direction that places the point or edge of the blade on the hand of the user. This can easily lead to injury. Many knives with replaceable blades also have elements of the handle parallel to the edge portion of the blade with gaps between the blade and the handle elements. This can make tasks like fileting a fish difficult and leave a mess because the parallel elements of the handle will catch on the fish and pieces of fish can get stuck between the blade and elements of the handle causing a mess that can quickly stink. Many knives with replaceable blades also require tools or complex steps to replace the blades.

### SUMMARY

One or more embodiments are provided below for a knife/device with a handle and replaceable blade. The device may include a handle and a blade. The handle may include a grip, a pivot pin, and a latch. The pivot pin may be fixed to the grip and has a first shape in a first plane. The latch may be fixed to the grip. The blade may include an edged portion, a connection portion, and a tang. The connection portion may be between the tang and the edged portion. The connection portion may define an opening with a second shape which compliments the first shape such that the pivot pin is capable of entering into or exiting out of the opening of the connection portion if the pivot pin has a first orientation relative to the connection portion and the pivot pin is not capable of exiting out of the opening of the connection portion if the pivot pin has a second orientation relative to the connection portion. The latch may be configured to secure the tang of the blade when the pivot pin has the second orientation relative to the connection portion.

The device may provide significant advantages over the devices known in the art. The device is simple to use and does not require any tools to replace the blade. The blade can be removed by pressing the latch to move the latch from a securing location and rotating the blade around the pivot pin away from the securing location to a removal orientation (first orientation). The pivot pin may be removed from the opening in the connection portion when the blade is in the removal orientation. A new blade may then be attached by placing the pivot pin into the opening on the new blade in the removal orientation then rotating the blade on the pivot pin to the section orientation and securing the new blade with the latch. In both the removal of the old blade and the placement of the new blade, one hand of the user's may be on the handle operating the latch and the other hand of the user may be placed on the spine (back) of the blade which (except in the case where the blade has two edges) means that the user's hands are never in danger of being cut by the blade. This is a significant improvement in safety over currently available knives that require the user to move and press the removable blade in a direction aligned with the point of the blade putting the user's hand in significant danger of being stabbed. As another advantage, because the knife does not require any elements of the handle to be aligned alongside the edged portion of the blade, there is considerably less risk of getting dirt/grime/gunk between the blade and the handle and provides for a significant improvement in cleanliness.

Other advantageous features as well as other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 shows an example side view of the internal components of the knife with the blade in a secured position.

FIG. 2 shows an example side view of the internal components of the knife with the blade in a removal position.

FIG. 3 shows an example side view of the separated blade and handle.

FIG. 4 shows an example side view of the knife with joined blade and handle.

FIG. 5 shows an example bottom view of the knife.

FIG. 6 shows an example top view of the knife.

FIG. 7 shows an example butt view of the knife.

### DETAILED DESCRIPTION

In the Summary above and in this Detailed Description, the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “coupled to” as used herein may mean a direct or indirect connection via one or more components.

Referring now to the drawings and the following written description of the present invention, it will be readily understood by those persons skilled in the art that the present invention is susceptible to broad utility and application. Many embodiments and adaptations of the present invention other than those herein described, as well as many variations, modifications, and equivalent arrangements will be apparent from or reasonably suggested by the present invention and the detailed description thereof without departing from the substance or scope of the present invention. This disclosure is only illustrative and exemplary of the present invention and is made merely for purposes of providing a full and enabling disclosure of the invention.

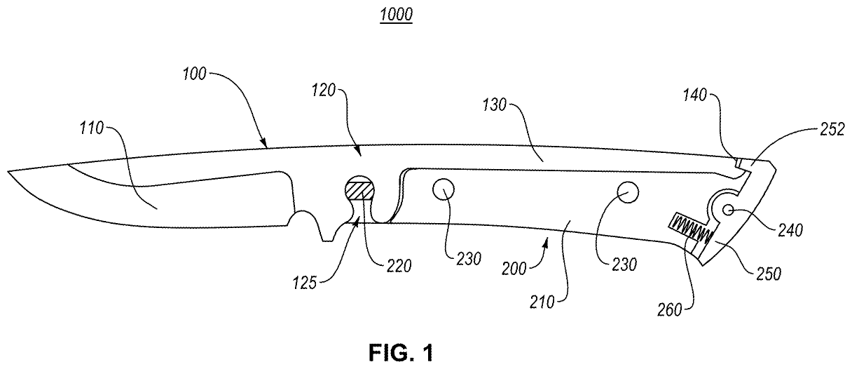

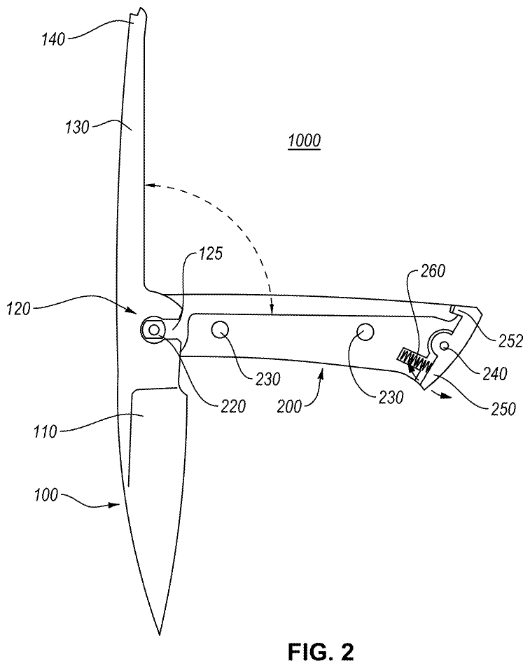

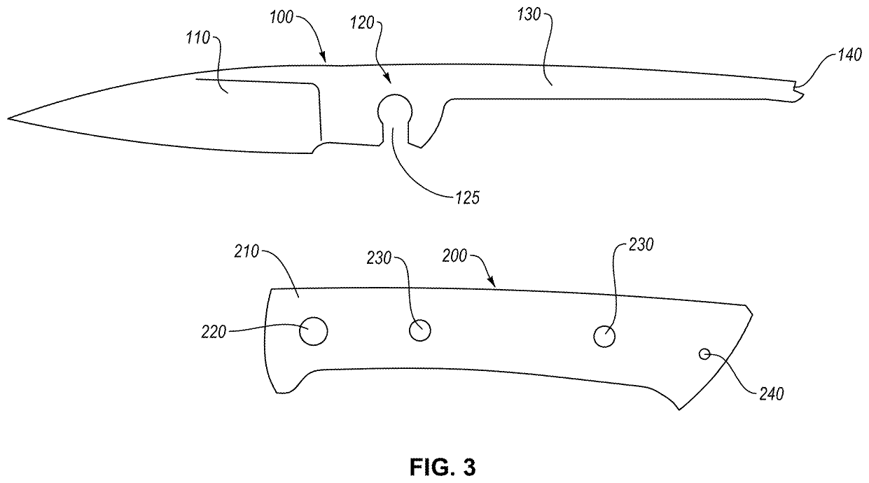

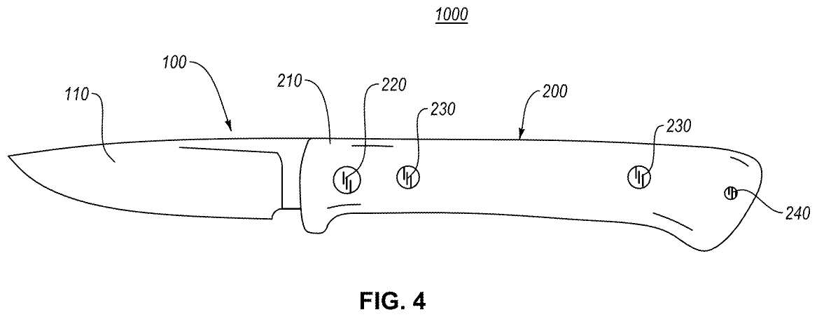

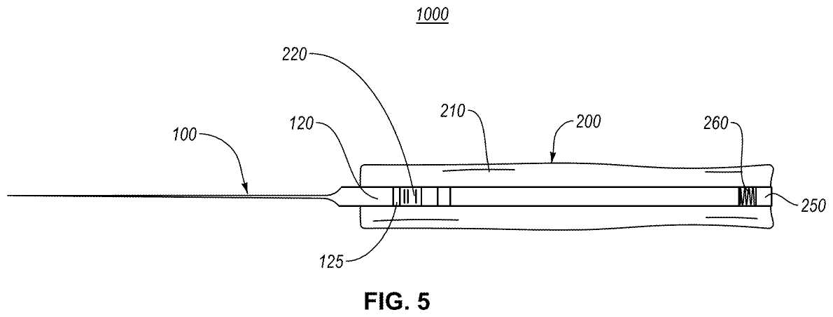

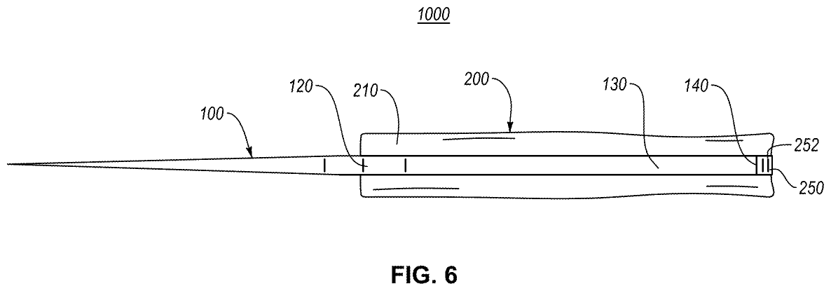

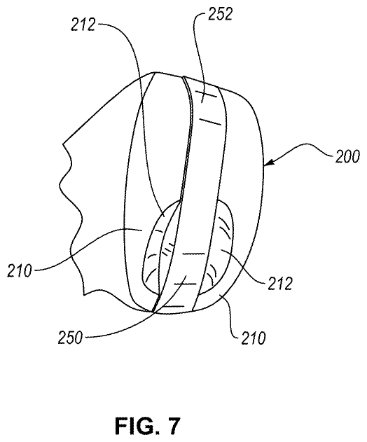

FIGS. 1-7 show example views of a knife 1000. FIG. 1 shows an example side view of internal components of the knife with the blade in a secured position. FIG. 2 shows an example side view of the internal components of the knife 1000 with the blade 100 in a removal position. The removal position may be an example of a first orientation and the secured position may be an example of a second orientation. FIG. 3 shows an example side view of separated blade 100 and a handle 200. FIG. 4 shows an example side view of the knife 1000 with joined blade 100 and handle 200. FIG. 5 shows an example bottom view of the knife 1000. FIG. 6 shows an example top view of the knife 1000. FIG. 7 shows an example butt view of the knife 1000.

The blade 100 may be made of a metal such as steel, or other durable material that can hold an edge. The blade 100 may be manufactured by cutting and grinding a sheet of metal. The blade 100 may include an edged portion 110, a connection portion 120, and a tang 130. The connection portion 120 may define an opening 125 and may be between the edged portion 110 and the tang 130. The tang may have a smaller width (first distance in the up-down direction from the perspective of FIG. 1) compared to the edged portion 110 (except at the tip) and the connection portion 120. The tang 130 may include a notch 140 at an end of the tang furthest from the edged portion 110. The notch 140 may be a square cut out. As will be described below, the notch 140 may allow the tang 130 to be secured onto the handle 200 without having any portion of the tang 130 sticking out from the handle 200. The end of the tang 130 may have a slanted side opposite the notch 140. As will be discussed in further detail below, the slant of the slanted side of the tang may assist the tang 130 in engaging with the handle 200 to secure the tang 130 to the handle 200 when the blade 100 has the second orientation relative to the handle 200.

The edged portion may have a length of about 1.5-11 inches (depending on the intended usage of the blade). The width and shape of the edged portion 110 may depend on the intended purpose of the blade. The edged portion 110 may have a spine and an edge. In some embodiments, the edged portion 110 may have an edge on two sides.

The connection portion may have a width similar to the widest portion of the edged portion 110. In some embodiments, the width of the connection portion 120 may be greater or smaller than the widest portion of the edged portion 110. The connection portion 120 may not include an edge. The connection portion 120 may define an opening 125. The opening may have a round cutout and a hole connecting the round cutout to an exterior of the blade in a first plane, the first plane being the plane the edged portion 110 and connection portion 120 primarily extend (have the longest features). The first plane being the plane of FIG. 1. The width of the hole in the first plane may be smaller than the width of a radius of the round cutout of the opening in the first plane. The hole of the opening 125 may have parallel sides extending in the same direction as the direction from the spine to the edge of the edged portion 110. Restated, the opening 125 may have a hole connecting the opening 125 to an exterior of the blade 100 in the same direction as the direction from the spine to the edge of the edged portion. The tang 130 and connecting portion 140 together may have a similar length as the handle 200.

The handle 200 may include a grip 210, a pivot pin 220, rivets 230, latch pin 240, latch 250, and spring 260. The grip 210 may include two shells joined by the rivets 230. The pivot pin 220 may be at or near a first end of the handle and the latch 250 may be at or near a second end of the handle 200 (at the butt of the knife 1000). The grip 210 may be made of wood, composite, plastic, metal, or other durable material suitable for gripping with the hand and withstanding the forces of using a knife to cut various objects.

The pivot pin 220 may pass through the grip 210 and/or be pinched between shells of the grip 210 such that the pivot pin 220 does not rotate relative to the grip 210. The pivot pin 220 may include metal or other durable materials suitable for securing a blade. The pivot pin 220 may have a shape which allows the pivot pin 220 to enter into and exit from the opening 125 in the connection portion 120 when the blade 100 has the first orientation (shown in FIG. 2) and does not allow the pivot pin 220 to enter into or leave the opening 125 in the connection portion when the blade 100 is in another position such as the second orientation (shown in FIG. 1). Because the opening has a round cutout with a diameter larger than the hole to the exterior of the opening, a shape in the first plane (plane shown in FIG. 1) with different lengths in one dimension than a second dimension may be used for the pivot pin. For example, a rectangle (with one dimension smaller than the width of the hole and one dimension larger than the width of the hole), an oval (with similar requirements to the rectangle), a football shape, an (non-equilateral) triangle, or even a concave shape such as a four-pointed star (with points of the star matching the corners of the above described rectangle) may be used. However, it may be advantageous to have a curved surface that matches the radius of the round cut out in the opening 125 on two opposite sides (first and second sides) and flat sides on the other two sides (third and fourth sides) as shown in FIGS. 1 and 2. The first orientation may be an orientation of the blade 100 where the hole of the opening 125 is aligned about perpendicular to the third side and the fourth side of the pivot pin 220. The second orientation may be an orientation of the blade 100 where the hole of the opening 125 is not aligned about perpendicular to the third side and the fourth side of the pivot pin 220.

It is advantageous to have a close fit between the pivot pin and the round cutout of the opening 125 to reduce movement of the blade 100 relative to the handle and reduce the chance of the latch 250 inadvertently coming off the tang 130. Sharp corners grinding on the interior of the round cut out of the opening 125 are more easily worn down by rotating within the opening 125 than a curved surface that matches the curvature of the round cutout. Accordingly, the curved surface on two opposite sides (with a distance between the curved surfaces at least larger than the width of the hole (first distance) in the opening 125) and flat surfaces on the other two opposite sides (with a distance between the two flat surfaces being a second distance which is less than the first distance) may be preferred.

The latch pin 240 may pass through the shells of the grip 210 and also through the latch 250. The latch 250 may be fixed to the grip 210 via the latch pin 240. The latch 250 may be able to rotate around the latch pin 240. The latch 250 may extend away from the latch pin 240 in two opposite directions to a first end and a second end. The first end may have a latch extension 252 which is shaped to interact with the notch 140 in the tang 130 of the blade to secure the blade 100 via the notch 140 in the tang 130 when the latch is in a securing position (shown in FIG. 1) with the spring 260 pressing the latch extension 252 into the notch 140 in the tang 130 of the blade 100. The spring 260 may be between the latch 150 and the grip 210. The spring 260 may be a metal spring or another material with a restoring force that may be used to press on an object. The spring 260 may press on the second end (the end opposite of latch extension 252) of the latch 250 to push the latch 250 into the securing position and maintain the latch 250 in the securing position. When the spring is compressed by the user's finger (or otherwise compressed) the latch 250 may be rotated into a non-securing position where the latch extension 252 is not in the notch 140. The securing position may be an example of a third orientation. The non-securing position may be an example of a fourth orientation.

The rivets 230, latch pin 240, and latch 250 may include metal or other durable material suitable for securing various elements of the knife 1000.

The blade 100 can be removed by pressing the latch 250 to move the latch extension 252 from a securing location (e.g. from the third orientation to the fourth orientation) and rotating the blade 100 around the pivot pin 220 away from the securing location to a removal orientation (e.g., from the second orientation to the first orientation). The pivot pin 220 may be removed from the opening 125 through the hole in the opening 125 when the blade 100 is in the removal orientation (first orientation). A new blade 100 may then be attached by placing the pivot pin 220 into the opening 125 on the new blade in the removal orientation then rotating the blade 100 on the pivot pin 220 to the second orientation and securing the new blade 100 with the latch 250. The opening 125 may have a second shape which compliments the first shape of the pivot pin 220 such that the pivot pin is capable of entering into or exiting out of the opening 125 of the connection portion 120 if the pivot pin 220 has a first orientation relative to the connection portion 120 and the pivot pin 120 is not capable of exiting out of the opening 125 of the connection portion 120 if the pivot pin 220 has the second orientation relative to the connection portion 120. Restated, the first shape may be capable of rotating within the second shape in the first plane such that the blade 100 is capable of rotating relative to the handle 200 while the pivot pin 220 is in the opening 125.

The blade 100 may be selectively, rotatably, attachable to the handle 200 via the pivot pin 220. The latch 250 may be configured to secure the tang 130 of the blade 100 to prevent the blade 100 from rotating relative to the handle 100. The pivot pin 220 may be capable of selectively attaching by entering into the opening 125 of the connection portion 120 if the pivot pin 220 has the first orientation relative to the connection portion 120 and the pivot pin 220 may not be capable of exiting out of the opening 125 if the pivot pin 220 rotates within the opening 125 to a second orientation relative to the connection portion 120. The blade 100 may be rotatably attachable in that the blade 100 may be attached to the handle 200 and be able to rotate relative to the handle 200 when attached. The blade 100 may be selectively attachable and detachable from the handle because the blade 100 can be moved to a position where the blade 100 can be attached and detached or can be moved to a position where the blade 100 cannot be attached or detached. Accordingly, by selecting the position of the blade 100, the ability to be attachable is selected, thus the blade 100 is selectively attachable and detachable from the handle 200.

As can be seen in FIG. 4, the tang 130 of the blade 100 may fit into the grip 210 of the handle such that the tang 130 does not stick out enough to be seen from a side view of the knife 1000. This feature may increase comfort for a user's hand. Further, the tang 130 extending the length of the handle under where a user would secure the knife 1000 with the user's hand may improve safety because the user's hand may further add to the security of the blade by pressing the tang 130 into the grip 210 and not allowing the blade 100 to rotate relative to the handle 200. Having tang 130 extend straight from the spine of the edged portion also increases security by having the natural rotational force around the pivot pin 220 when cutting with the edge of the edged portion 110 causing the tang 130 to be pressed into the grip 210. Even if the blade 100 includes two edges and cutting is performed with the edge on the same side of the blade 100 as the tang 130 the user's hand gripping the blade to the grip 210 may provide additional security and safety beyond that of the latch 150.

As can be seen in FIG. 7, the grip 210 may include an indent 212 on either side of the latch 250 to more easily allow a user's finger to press the latch 250 to move the latch 250 from the third orientation to the fourth orientation.

Many different embodiments of the inventive concepts have been shown. A person of ordinary skill in the art will appreciate that the features from different embodiments may be combined or replaced with other features from different embodiments.

Advantageously, the device is simple to use and does not require any tools to replace the blade 100. In both the removal of the old blade 100 and the placement of the new blade 100, one hand of the user's may be on the handle operating the latch 250 and the other hand of the user may be placed on the spine of the blade 100 which (except in the case where the blade 100 has two edges) means that the user's hands are never in danger of being cut by the edge of the edged portion 110. This is a significant improvement in safety over currently available knives that require the user to move and press the removable blade in a direction aligned with the point of the blade, putting the user's hand in significant danger of being stabbed. As another advantage, because the knife does not require any elements of the handle to be aligned alongside the edged portion 210 of the blade, there is considerably less risk of getting dirt/grime/gunk between the blade and the handle and provides for a significant improvement in cleanliness. Also, the extension of the tang 130 along the handle gives extra safety and security when using the knife 1000 from the user's hand pressing the tang 130 into the handle 210.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A device comprising:
a handle including a grip, a pivot pin, and a latch, wherein the pivot pin is fixed to the grip and has a first shape in a first plane, and wherein the latch is fixed to the grip; and
a blade including an edged portion, a connection portion, and a tang, wherein the connection portion is between the tang and the edged portion, wherein the connection portion defines an opening with a second shape which compliments the first shape such that the pivot pin is capable of entering into or exiting out of the opening of the connection portion if the pivot pin has a first orientation relative to the connection portion and the pivot pin is not capable of exiting out of the opening of the connection portion if the pivot pin has a second orientation relative to the connection portion, and wherein the latch is configured to secure the tang of the blade when the pivot pin has the second orientation relative to the connection portion.

2. The device of claim 1, wherein the first shape in the first plane includes a first side and a second side opposite the first side.

3. The device of claim 2, wherein the first shape in the first plane includes a third side and a fourth side opposite the third side, the distance between the third side and the fourth side being a first distance, and wherein the opening includes a hole with a width of a second distance, wherein the first distance is less than the second distance.

4. The device of claim 3, wherein the first orientation is an orientation of the first blade where the hole of the opening is aligned about perpendicular to the third side and the fourth side.

5. The device of claim 3, wherein the distance between the first side and the second side is greater than the second distance.

6. The device of claim 4, wherein the first side and the second side are curved.

7. The device of claim 1, wherein the second orientation is an orientation of the blade where the opening is not aligned about perpendicular to the third side and the fourth side.

8. The device of claim 1, wherein the handle further includes a latch pin fixed to the grip, wherein the latch is configured to rotate around the latch pin from a third orientation to a fourth orientation, wherein in the third orientation the latch is configured to secure the tang of the blade when the pivot pin has the second orientation relative to the connection portion and in the fourth orientation the latch is not configured to secure the tang of the blade.

9. The device of claim 8, wherein the handle further includes a spring configured to maintain the latch in the third orientation.

10. The device of claim 8, wherein the tang of the blade further includes a notch configured to interact with the latch to secure the tang of the blade.

11. A device comprising:
a blade including an edged portion, a connection portion, and a tang, wherein the connection portion is between the tang and the edged portion; and
a handle including a grip, a pivot pin, and a latch, wherein the pivot pin is fixed to the grip and has a first shape in a first plane, and wherein the latch is fixed to the grip, wherein the connection portion defines an opening with a second shape, wherein the first shape is capable of rotating within the second shape in the first plane such that the blade is capable of rotating relative to the handle while the pivot pin is in the opening, wherein the latch is configured to secure the tang of the blade to prevent the blade from rotating relative to the handle.

12. The device of claim 11, wherein the handle further includes a latch pin fixed to the grip, wherein the latch is configured to rotate around the latch pin from a third orientation to a fourth orientation, wherein in the third orientation the latch is configured to secure the tang of the blade and in the fourth orientation the latch is not configured to secure the tang of the blade.

13. The device of claim 12, wherein the handle further includes a spring configured to maintain the latch in the third orientation.

14. The device of claim 12, wherein the tang of the blade further includes a notch configured to interact with the latch to secure the tang of the blade.

15. A device comprising:
a handle including a grip, a pivot pin, and a latch, wherein the pivot pin is fixed to the grip and has a first shape in a first plane, and wherein the latch is fixed to the grip; and
a blade including an edged portion, a connection portion, and a tang, wherein the connection portion is between the tang and the edged portion, wherein the blade is selectively, rotatably, attachable to the handle via the pivot pin, and wherein the latch is configured to secure the tang of the blade to prevent the blade from rotating relative to the handle.

16. The device of claim 15, wherein the pivot pin is capable of selectively attaching by entering into an opening of the connection portion if the pivot pin has a first orientation relative to the connection portion and the pivot pin is not capable of exiting out of the opening of the connection portion if the pivot pin rotates within the opening to a second orientation relative to the connection portion.

17. The device of claim 16, wherein the handle further includes a latch pin fixed to the grip, wherein the latch is configured to rotate around the latch pin from a third orientation to a fourth orientation, wherein in the third orientation the latch is configured to secure the tang of the blade when the pivot pin has the second orientation relative to the connection portion and in the fourth orientation the latch is not configured to secure the tang of the blade.

18. The device of claim 17, wherein the handle further includes a spring configured to maintain the latch in the third orientation.

19. The device of claim 17, wherein the tang of the blade further includes a notch configured to interact with the latch to secure the tang of the blade.
